(19) United States
(12) Patent Application Publication
(10) Pub. No.: US 2014/0098328 A1
(43) Pub. Date: Apr. 10, 2014

(54) VA Display Mode Compensation Architecture and VA Display Mode Liquid Crystal Display Device

(71) Applicant: Shenzhen China Star Optoelectronics Technology Co., LTD., Shenzhen City, Guangdong Province (CN)

(72) Inventors: Chihtsung Kang, Shenzhen City (CN); Bo Hai, Shenzhen City (CN)

(21) Appl. No.: 13/807,712

(22) PCT Filed: Oct. 19, 2012
(86) PCT No.: PCT/CN2012/083165

§ 371 Date: Dec. 28, 2012

(30) Foreign Application Priority Data
Oct. 10, 2012 (CN) 201210382235.2

(51) Int. Cl. G02F 1/13363

(52) U.S. Cl. CPC G02F 1/133634
USPC 349/96

(57) ABSTRACT

The present invention relates to a VA display mode compensation architecture and a VA display mode liquid crystal display device. The VA display mode compensation architecture includes, sequentially from top to bottom, a first TAC layer, a first polarization layer, a biaxial compensation film, a VA LC cell, a second TAC layer, a second polarization layer, and a third TAC layer. The horizontal viewing angle of the VA LC cell and thus the VA liquid crystal display is taken as 0 degree for reference. The first polarization layer has an absorption axis that is set at 0 degree. The biaxial compensation film has a slow axis that is set at 90 degrees. The second TAC layer has a slow axis that is set at 0 degree. The second polarization layer has an absorption axis that is set at 90 degrees.

### BACKGROUND OF THE INVENTION

1. Field of the Invention

The present invention relates to a liquid crystal display device, and in particular to a VA (Vertical Alignment) display mode compensation architecture and a VA display mode liquid crystal display device.

2. The Related Arts

A thin-film transistor liquid crystal display (TFT LCD) is one of active matrix liquid crystal displays (AM-LCDs). A liquid crystal flat panel display, especially the TFT-LCD, is the only one of the currently available display devices that can come up with or even get beyond CRT display devices in respect of general performance including brightness, contrast, power consumption, lifespan, volume, and weight. The liquid crystal flat panel display has excellent performance, is good for mass production with high level of automation, uses low cost material, has a prosperous future of development, and will thus become the main stream product in the new era and a bright spot of global economic growth for the 21st century.

However, with the viewing angle of the TFT-LCD being increasingly enlarged, the contrast of image screen is getting lower and the sharpness of image is getting worse. This simply results from birefringence of the liquid crystal molecules contained in the liquid crystal layer varying with the viewing angle. For a regular liquid crystal display screen, when the regular liquid crystal display screen is observed at a specific viewing angle, the brightness gets lost (becoming dark) very rapidly and color may get varied. The traditional liquid crystal display has a viewing angle of 90 degrees, meaning 45 degrees for both left side and right side. If there is only one viewer watching the display, this issue may be simply neglected, such as in the case of a notebook computer. However, for more than one viewer watching the display, for example when a person whishes to show a specific image to guests or a number of people play the same game together, the only result is viewers complaining how poor the quality of the display is.

The nematic liquid crystal that is used to make a liquid crystal display is a substance having birefringence Δn. Light passing through the liquid crystal molecules is divided into two rays including an ordinary ray and an extraordinary ray. If light is projected onto the liquid crystal molecules in an inclined manner, then two refracted rays are generated. The birefringence Δn=ne−no, where ne is the refractive index of the liquid crystal molecules with respect to the ordinary ray, while no is the refractive index of the liquid crystal molecules with respect to the extraordinary ray. Consequently, when the light passes through liquid crystal molecules sandwiched between upper and lower glass plates, a phenomenon of phase retardation occurs on the light. The optic characteristic of a liquid crystal cell is often assessed by means of phase retardation LC Δnd, which is also referred to as optical path difference, where Δn is birefringence and d is the thickness of the liquid crystal cell. The viewing angle problem of a liquid crystal cell is caused by the phase retardation of the liquid crystal cell being different at different viewing angle. A suitable phase retardation caused by an optic compensation film can cancel the phase retardation of the nematic liquid crystal so that the viewing angle of the liquid crystal panel can be enlarged. The principle of compensation for an optic compensation film is to correct the phase difference caused by the liquid crystal molecules at different viewing angles to provide symmetric compensation to the characteristics of the birefringence of the liquid crystal molecules. Using an optic compensation film to effect compensation can effectively reduce light leaking in a dark state screen and can also greatly improve the contrast of the screen within a predetermined viewing angle.

The optic compensation film can be classified as a retardation film that simply change phase, a compensation film, viewing angle enlarging film, according to the function thereof. The use of optic compensation film helps reduces the light leaking in a dark state of a liquid crystal display and to greatly improves contrast and chromaticity of image and partly overcome the problem of grey level inversion. The primary parameters that are used to assess the characteristics of an optic compensation film include in-plane retardation (compensation) Ro (also referred to as Re) in a plane direction and thickness retardation (compensation) Rth (off plane retardation) in the thickness direction, refractive index N, and film thickness d, which satisfy the following equations:

Ro=(Nx−Ny)×d; and

Rth=[(Nx+Ny)/2−Nz]×d

wherein Nx stands for refractive index in the slow axis on the film plane (which is the axis that has the greatest refractive index, namely the vibration direction that light has a relatively slow propagation speed), Ny is refractive index in the fast axis on the film plane (which is the axis that has the smallest refractive index, namely the vibration direction that light wave has a relatively fast propagation speed, and is perpendicular to Nx), and Nz is refractive index in a film plane direction (perpendicular to Nx and Ny).

Heretofore, the manufacturers propose various wide viewing angle techniques to improve the viewing angle characteristics of a liquid crystal display, which include in-plane switching (IPS), multi-domain vertical alignment (MVA), patterned vertical alignment (PVA), and twisted nematic TFT-LCD+optic compensation film. All these techniques enlarges the viewing angle of a liquid crystal module to 160 degrees or greater. Different types of liquid crystal cell is also available for different liquid crystal display modes and the optic compensation films used are also different, where the values of Ro and Rth must be adjusted to proper values. Most of the optic compensation films currently available for large-sized liquid crystal televisions are made for vertical alignment (VA) display mode and have been evolved from the early N-TAC of Konica Corporation to the later Zeonor of Optes corporation, F-TAC of Fujitsu Corporation, and X-plate of Nitto Denko Corporation.

Referring to FIGS. 1A and 1B, architectures that are commonly used in VA display mode are illustrated. FIG. 1A shows a conventional single biaxial film compensation architecture for VA display mode, which comprises, from top to bottom, a TAO (Triacetyl Cellulose) layer 11, a PVA (Polyvinyl Alcohol) layer 12, a TAO layer 13, a PSA (Pressure Sensitive Adhesive) layer 14, a vertical alignment (VA) liquid crystal cell 15, a PSA layer 16, a biaxial compensation film 17, a PVA layer 18, and a TAO layer 19, in which there is only one single biaxial compensation film 17. FIG. 1B shows a conventional double biaxial film compensation architecture for VA display mode, which comprises, from top to bottom, a TAC layer 21, a PVA layer 22, a biaxial compensation film 23, a PSA layer 24, a VA liquid crystal cell 25, a PSA layer 26, a biaxial compensation film 27, a PVA layer 28, and a TAC layer 29, in which there are two biaxial compensation films, namely the biaxial compensation film 23 and the biaxial compensation film 27. FIGS. 1A and 1B generally illustrate the compensation architectures and other structures, such as glass substrates, are omitted. Actually, the VA liquid crystal cell is enclosed between two substrates. The PSA layer provides an effect of adhesive bonding. The PVA layer is a polarization layer made of polyvinyl alcohol and the specific way of arrangement can be determined according to the angle of the absorption axis thereof. The TAC layer is primarily for protecting the PVA layer, improving mechanical performance of the PVA layer, and preventing contraction of the PVA layer. Each TAC layer has off plane retardation Rth.

Referring to FIGS. 2A and 2B, FIG. 2A is a schematic view showing light leaking distribution in dark state of the compensation architecture illustrated in FIG. 1A and FIG. 2B is a schematic view showing light leaking distribution in dark state of the compensation architecture illustrated in FIG. 1B. For a VA liquid crystal cell, the dark state is when the driving voltage of liquid crystal is equal to zero. The light leaking distribution of FIGS. 2A and 2B is illustrated in terms of brightness with respect to viewing angle, wherein four concentric circles are shown in each of the drawings and respectively indicate, from inside to outside, vertical viewing angle of 20 degrees, 40 degrees, 60 degrees, and 80 degrees. The digits marked outside the 80-degree circle indicate horizontal viewing angle. Since the optic compensation film does not vary with voltage as the liquid crystal does, it is generally impossible to have all grey scales be compensated. Thus, compensation is often made for the dark state of the liquid crystal to improve the contrast at a large viewing angle.

As shown in FIG. 3, a schematic view, which illustrates setting the angles of the slow axis and absorption axis of the compensation architecture shown in FIG. 1A, is given to demonstrate setting of the conventional single biaxial film compensation architecture and the angles of the slow axis and the absorption axis thereof. A TAC layer 11, a PVA layer 12, a TAC layer 13, a PSA layer 14, a VA liquid crystal cell 15, the PSA layer 16, a biaxial compensation film 17, a PVA layer 18, and a TAC layer 19 are sequentially stacked from top to bottom. By taking horizontal viewing angle of the VA liquid crystal cell 15 as 0 degree for reference, the absorption axis of the PVA layer 12 is set at 0 degree, the slow axis of the TAC layer 13 is set at 90 degrees, the slow axis of the biaxial compensation film 17 is set at 0 degree, and the absorption axis of the PVA layer 18 is set at 90 degrees.

TABLE 1
LC Δnd and compensation values used in single biaxial
film compensation architecture illustrated in FIG. 2A

| | single biaxial | single biaxial | |
|---|---|---|---|
| LC Δnd | compensation | compensation | TAC layer |
| of VA LC cell | film Ro | film Rth | Rth |
| 352.1 nm | 72 nm | 240 nm | 35.4 nm |

With reference to the above Table 1, the single biaxial film compensation architecture shown in FIG. 2A can be set according to the values of LC Δnd and compensation values. The LC Δnd (phase retardation) of the VA liquid crystal cell 15 is 352.1 nm, the in-plane retardation Ro of the biaxial compensation film 17 is 72 nm, the thickness retardation Rth of the biaxial compensation film 17 is 240 nm, and thickness retardation Rth of the TAC layer 13 is 35.4 nm. It can be found that severe light leaking occurs at the horizontal viewing angle phi=20-40 degrees, phi=140-160 degrees, phi=200-220 degrees, and phi=310-330 degrees. Namely, dark state light leaking is severe at viewing angles close to the horizon. Thus, the viewing angles at which the dark state light leaking of the conventional single biaxial film compensation architecture are those close to horizontal viewing angle.

FIGS. 2A and 2B show that for compensation made with a conventional double biaxial film compensation architecture, the viewing angles at which the dark state light leaking gets severe are between horizontal and vertical viewing angles. Compared to compensation made with double biaxial film compensation architecture, compensation made with the conventional single biaxial film compensation architecture has severe dark state light leaking at viewing angles that are closer to the horizontal viewing angle. The relative position between the viewers and the liquid crystal display screen determines that the viewing angles that are close to the horizon is easer to be viewed by the viewers. Thus, the contrast and sharpness at these viewing angles are of the greatest influence on the result of viewing. A large viewing angle is not easy to be watched and is thus of less influence on the viewers. Thus, it is desired to limit the light leaking area to be around the vertical viewing angle. To improve the result of viewing, it is desired to use the double biaxial film compensation architecture, yet it is of a higher price, making it difficult to lower down cost. Although using a single biaxial film compensation architecture to effect compensation can effectively lower down the cost, yet at the viewing angles that are close to the horizon, the dark state light leaking is severe, the contrast is low, and thus the result of viewing is affected.

### SUMMARY OF THE INVENTION

Thus, an object of the present invention is to provide a VA display mode compensation architecture, which makes viewing angle with severe dark state light leaking shifting toward the vertical viewing angle to improve contrast and sharpness at viewing angles close to the horizon.

Another object of the present invention is to provide a VA display mode liquid crystal display device, which has a severe dark state light leaking zone that is close to upper and low vertical viewing angle and reduces dark state light leaking at viewing angles close to the horizontal viewing angle to effectively improve contrast and sharpness of viewing angles close to the horizontal viewing angle.

To achieve the objects, the present invention provides a VA display mode compensation architecture, which comprises, sequentially from top to bottom, a first TAC layer, a first polarization layer, a biaxial compensation film, a VA LC cell, a second TAC layer, a second polarization layer, and a third TAC layer, wherein the horizontal viewing angle of the VA LC cell and thus the VA liquid crystal display is taken as 0 degree for reference. The first polarization layer has an absorption axis that is set at 0 degree. The biaxial compensation film has a slow axis that is set at 90 degrees. The second TAC layer has a slow axis that is set at 0 degree. The second polarization layer has an absorption axis that is set at 90 degrees.

Wherein, the first polarization layer and the second polarization layer are PVA layers.

Wherein, the VA LC cell is provided, respectively at upper and lower sides thereof, with PSA layers.

Wherein, the VA LC cell has phase retardation LC Δnd that is 342.8-361.4 nm.

Wherein, the VA LC cell has a pre-tilt angle having a range of [85, 90) degrees.

Wherein, the biaxial compensation film has in-plane retardation Ro that is 54-78 nm and the biaxial compensation film has a thickness retardation Rth that is 180-260 nm.

Wherein, the VA LC cell is a multi-domain VA LC cell.

Wherein, the VA LC cell is a four-domain or eight-domain VA LC cell.

The present invention also provides a VA display mode compensation architecture, which comprises, sequentially from top to bottom, a first TAC layer, a first polarization layer, a biaxial compensation film, a VA LC cell, a second TAC layer, a second polarization layer, and a third TAC layer, wherein the horizontal viewing angle of the VA LC cell and thus the VA liquid crystal display is taken as 0 degree for reference, the first polarization layer having an absorption axis that is set at 0 degree, the biaxial compensation film having a slow axis that is set at 90 degrees, the second TAC layer having a slow axis that is set at 0 degree, and the second polarization layer having an absorption axis that is set at 90 degrees;

wherein the first polarization layer and the second polarization layer are PVA layers;

wherein the VA LC cell is provided, respectively at upper and lower sides thereof, with PSA layers;

wherein the VA LC cell has phase retardation LC Δnd that is 342.8-361.4 nm;

wherein the VA LC cell has a pre-tilt angle having a range of [85, 90) degrees;

wherein the biaxial compensation film has in-plane retardation Ro that is 54-78 nm and the biaxial compensation film has a thickness retardation Rth that is 180-260 nm;

wherein the VA LC cell is a multi-domain VA LC cell; and

wherein the VA LC cell is a four-domain or eight-domain VA LC cell.

The present invention further provides a display mode liquid crystal display device, which comprises, sequentially from top to bottom, a first TAC layer, a first polarization layer, a biaxial compensation film, a first substrate, a VA LC cell, a second substrate, a second TAC layer, a second polarization layer, and a third TAC layer, wherein the horizontal viewing angle of the VA LC cell and thus the VA mode liquid crystal display device is taken as 0 degree for reference. The first polarization layer has an absorption axis that is set at 0 degree. The biaxial compensation film has a slow axis that is set at 90 degrees. The second TAC layer has a slow axis that is set at 0 degree. The second polarization layer has an absorption axis that is set at 90 degrees.

The present invention provides a VA display mode compensation architecture, which angularly shift viewing angles that have severe dark state light leaking toward the vertical viewing angles so as to improve contrast and sharpness of the viewing angles close to the horizontal viewing angles. With proper compensation value of the single biaxial compensation film and proper compensation value of the TAC layer, idea result of dark state light leaking can be achieved. The VA display mode liquid crystal display device has a sever dark state light leaking zone that is close to the upper and lower viewing angles and the dark state light leaking of viewing angles that are close to the horizontal viewing angles is apparently reduce to thereby effectively improve the contrast and sharpness of viewing angles close to the horizontal viewing angles.

### BRIEF DESCRIPTION OF THE DRAWINGS

The technical solution, as well as beneficial advantages, will be apparent from the following detailed description of an embodiment of the present invention, with reference to the attached drawings. In the drawings:

FIG. 1A is a schematic view showing a conventional single biaxial film compensation architecture for VA display mode;

FIG. 1B is a schematic view showing a conventional double biaxial film compensation architecture for VA display mode;

FIG. 2A is a schematic view showing light leak distribution in dark state of the compensation architecture illustrated in FIG. 1A;

FIG. 2B is a schematic view showing light leak distribution in dark state of the compensation architecture illustrated in FIG. 1B;

FIG. 3 is a schematic view illustrating setting the angles of slow axis and absorption axis of the compensation architecture shown in FIG. 1A;

FIG. 4 is a schematic view illustrating a VA display mode compensation architecture according to the present invention and setting if angles of slow axis and absorption axis thereof;

FIG. 5 is a schematic view showing light leaking distribution in dark state of the compensation architecture illustrated in FIG. 4;

FIG. 6 is a schematic view illustrating architecture of a VA display mode liquid crystal display device according to the present invention;

FIG. 7 is a schematic view illustrating variation of light leaking with respect to compensation value for LC Δnd=342.8 nm and dark stat light leaking concentrated at large viewing angles;

FIG. 8 is a schematic view illustrating variation of light leaking with respect to compensation value for LC Δnd=361.4 nm and dark stat light leaking concentrated at large viewing angles; and

FIG. 9 is a schematic view illustrating dark state light leaking distribution after improvement made by using the VA display mode compensation architecture according to the present invention.

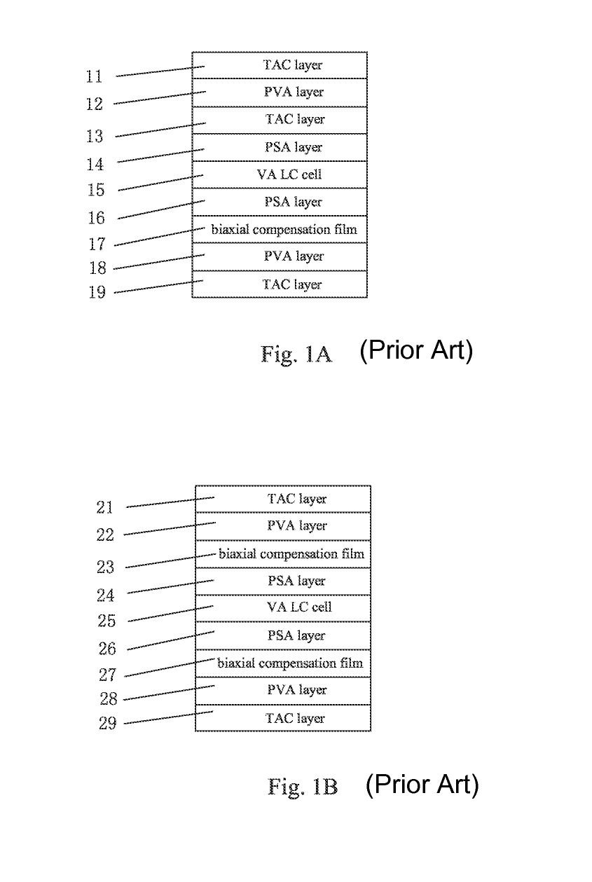

### DETAILED DESCRIPTION OF THE PREFERRED EMBODIMENTS

Referring to FIG. 4, a schematic view is given to illustrate a VA display mode compensation architecture according to the present invention and setting of angles of slow axis and absorption axis thereof. The VA display mode compensation architecture according to the present invention generally comprises, sequentially from top to bottom, a first TAC layer 41, a first PVA layer 42, a biaxial compensation film 43, a VA LC cell 45, a second TAC layer 47, a second PVA layer 48, and a third TAC layer 49. By taking horizontal viewing angle of the VA liquid crystal cell 45 as 0 degree for reference, the absorption axis of the first PVA layer 42 is set at 0 degree, the slow axis of the biaxial compensation film 43 is set at 90 degrees, the slow axis of the second TAC layer 47 is set at 0 degree, and the absorption axis of the second PVA layer 48 is set at 90 degrees. This preferred embodiment changes the conventional single biaxial film compensation architecture by angularly shifting dark state light leaking viewing angle toward vertical viewing angle. To serve as a compensation architecture, it is applicable to all kinds of liquid crystal display device that includes a VA LC cell. Upper and lower sides of the VA LC cell 45 can be respectively provided with a first PSA layer 44 and a second PSA layer 46 for adhesively coupling structures such as glass substrates.

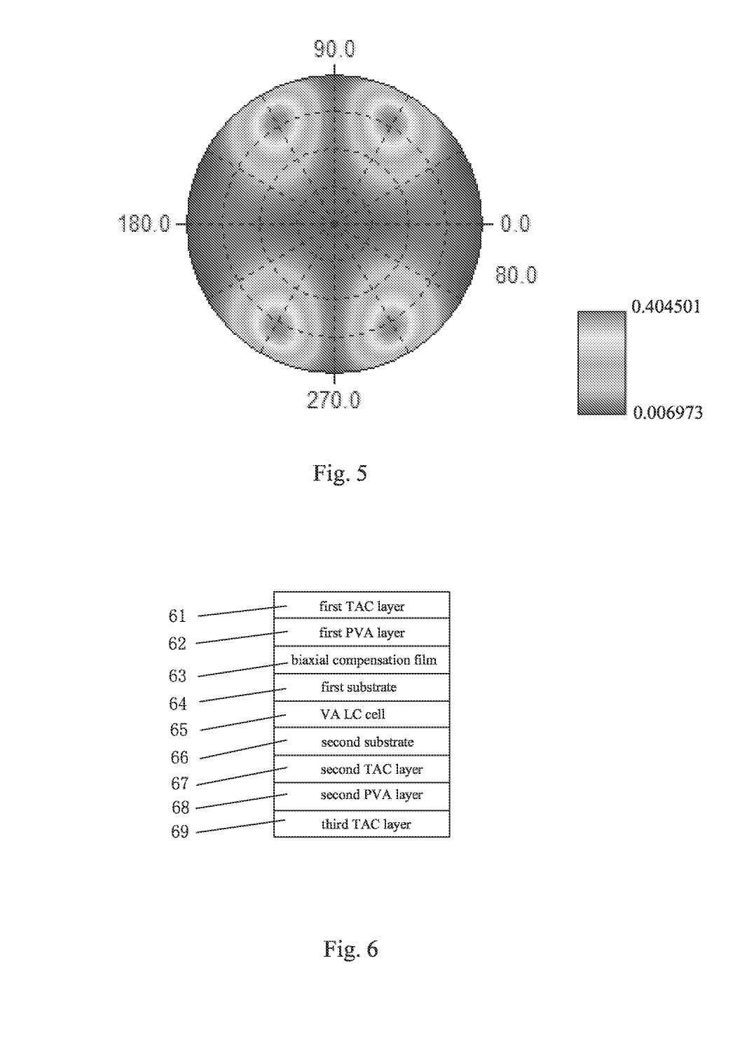

Referring to FIG. 5, by applying the same compensation parameters listed in the previous Table 1 to the compensation architecture shown in FIG. 4, a schematic view of light leaking distribution in dark state shown in FIG. 5 can be obtained. The light leaking distribution of FIG. 5 is illustrated in terms of brightness with respect to viewing angle, wherein four concentric circles are shown in the drawing and respectively indicate, from inside to outside, vertical viewing angle of 20 degrees, 40 degrees, 60 degrees, and 80 degrees. It can be seen from FIG. 5 that the severe dark state light leaking zones are close to upper and lower vertical viewing angles and the dark state light leaking is substantially reduced at viewing angles close to the horizontal viewing angles. This effectively improves the contrast and sharpness at viewing angles that are close to the horizontal viewing angles.

Referring to FIG. 6, a schematic view is given to illustrate architecture of a VA display mode liquid crystal display device according to the present invention. The VA display mode liquid crystal display device of the present invention generally comprises, sequentially from top to bottom, a first TAC layer 61, a first PVA layer 62, a biaxial compensation film 63, a first substrate 64, a VA LC cell 65, a second substrate 66, a second TAC layer 67, a second PVA layer 68, and a third TAC layer 69. By taking horizontal viewing angle of the VA liquid crystal cell 65 as 0 degree for reference, the absorption axis of the first PVA layer 62 is set at 0 degree, the slow axis of the biaxial compensation film 63 is set at 90 degrees, the slow axis of the second TAC layer 67 is set at 0 degree, and the absorption axis of the second PVA layer 68 is set at 90 degrees. FIG. 6 is an example illustrating application of the VA display mode compensation architecture according to the present invention to a VA display mode liquid crystal display device and showing only the primary structure of the liquid crystal display device, but actually, the liquid crystal display device also comprises other structures, such as an LC cell driving circuit. Upper and lower sides of the VA LC cell 65 can be respectively provided with a PSA layer.

For the VA display mode compensation architecture and the VA display mode liquid crystal display device of the present invention, to ensure light leaking is limited at locations close to upper and lower vertical viewing angles and to further ensure the amount and range of light leaking are made as small as possible, various single biaxial film compensation values and TAC compensation values can be used to simulate dark state light leaking in order to identify a desired range of compensation value to which the dark state light leaking corresponds.

The architecture shown in FIG. 6 is taken as an example in the following description, wherein through adjusting the compensation values (retardation values) of the biaxial compensation film 63 and the second TAC layer 67, simulation can be made for dark state light leaking and then desired ranges of compensation values can be identified to correspond to the dark state light leaking. Pre-tilt angle of the VA LC cell 65 is set to be [85,90) degrees. The VA LC cell 65 is set as a four-domain VA LC cell, with tilting angles of liquid crystal being respectively 45 degrees, 135 degrees, 225 degrees, and 315 degrees. The phase retardation LC Δnd is in the range of [342.8, 361.4] nm. The light source used is set to simulate the spectrum of blue-YAG LED with central brightness being 100 nits and light distribution being Lambert's distribution.

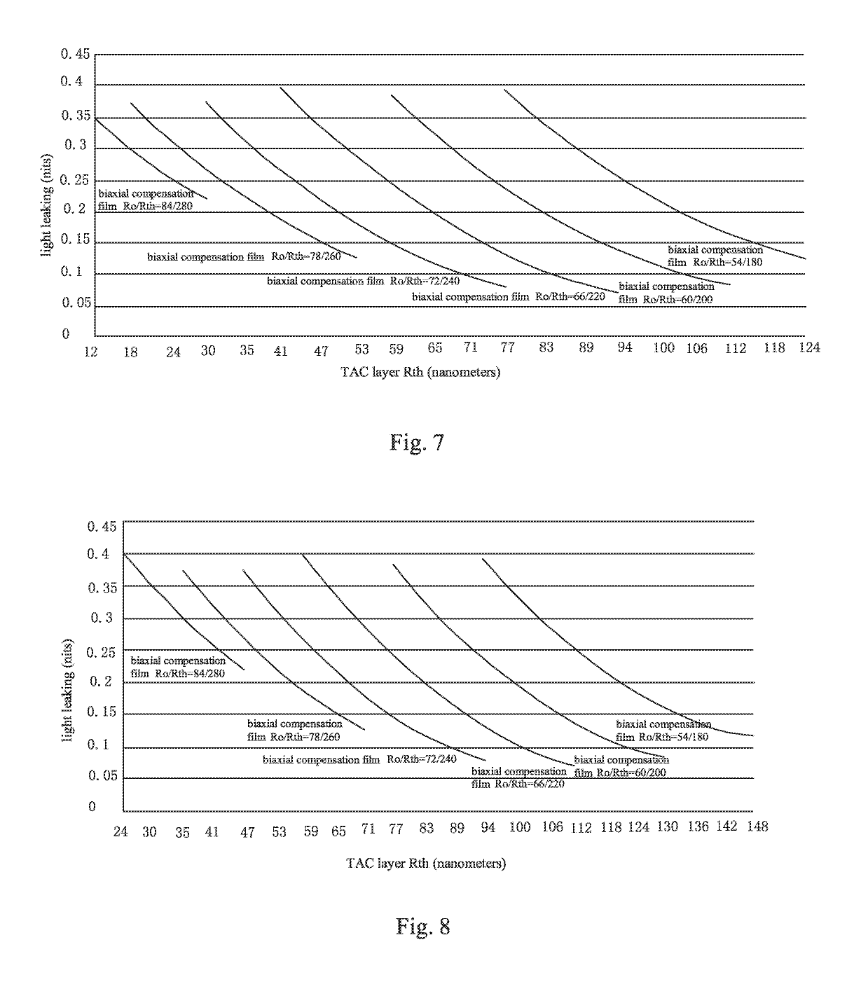

Taking LC Δnd=342.8 nm and 361.4 nm and pre-tilt angle=89 degrees as examples for explanation. Through using various single biaxial film compensation values and TAC compensation values to carry out simulation, the optimum ranges of compensation values that correspond to relatively small amount of dark state light leaking and range of light leaking can be identified. The results of simulation are shown in FIGS. 7 and 8, of which FIG. 7 is a schematic view illustrating variation of light leaking with respect to compensation value for LC Δnd=342.8 nm and dark stat light leaking concentrated at large viewing angles and FIG. 8 is a schematic view illustrating variation of light leaking with respect to compensation value for LC Δnd=361.4 nm and dark stat light leaking concentrated at large viewing angles.

In the simulation, it is found that at different pre-tilt angels, the influence of the single biaxial compensation film compensation value and the TAC compensation value on dark state light leaking show similar trends. Namely, for different pre-tilt angles, the ranges of compensation value corresponding to the minimum dark state light leaking are identical. As shown in the following Table 2, based on the result of simulation, the ranges of compensation values of the signal biaxial compensation film and TAC that correspond to the range of LC Δnd being [342.8, 361.4] nm, pre-tilt angle being within the range of [85,90) degrees, dark state light leaking being less than 0.2 nits (the dark state light leaking value being obtained with simulation made for pre-tilt angle=89 degrees, not an actually measured value).

TABLE 2
Ranges of Compensation Values of Single Biaxial Compensation
Film and TAC Corresponding to Dark State Light Leaking Being
Less Than 0.2 nits (Pre-Tilt Angle = 89 Degrees)

| | single biaxial | single biaxial | |
|---|---|---|---|
| LC Δnd | compensation | compensation | TAC layer |
| (nm) | film Ro (nm) | film Rth (nm) | Rth (nm) |
| [342.8, 361.4] | [54, 78] | [180, 260] | [Y₁, Y₂] |

For the range of Rth of the TAC layer, Y₁ = 0.0042x² − 2.6516x + 445.88 and Y₂ = −0.0021x² − 0.0169x + 218.3, where x is the Rth value of the single biaxial compensation film.

For the range of LC Δnd within [342.8, 361.4] nm and the range of pre-tilt angle within [85,90) degrees, the VA display mode compensation architecture and the VA display mode liquid crystal display device according to the present invention change the conventional single biaxial film compensation architecture to angularly shift the viewing angles that are of severe dark state light leaking toward the vertical viewing angles. Further, the signal biaxial compensation value and the TAC layer compensation value are changed to reduce the dark state light leaking and to ensure light leaking can be limited within a small range. Namely, in the range of [342.8, 361.4] nm of the phase retardation LC Δnd of the VA LC cell and the range of [85, 90) of the pre-tilt angle, through use of proper compensation value of the single biaxial compensation film and the proper compensation value of the TAC layer, ideal result of dark state light leaking can be achieved.

With proper compensation value ranges being identified and with the relationship among the compensation values Ro and Rth and refractive index N and thickness d being known as follows:

Ro=(Nx−Ny)×d; and

Rth=[(Nx+Ny)/2−Nz]×d,

the following three approaches can be used in a practical design to change the compensation values:

(1) On the basis of the refractive index N of the single biaxial compensation film and the TAC layer, the thickness d is changed to change the compensation values;

(2) On the basis of the thickness d of the single biaxial compensation film and the TAC layer, the refractive index N is changed to change the compensation values; and

(3) On the basis of the range of compensation value Rth of the single biaxial compensation film and the TAC layer being maintained, the thickness d and the refractive index N are simultaneously changed to change the compensation values.

Thus, the problem of severe dark state light leaking at viewing angles close to the horizontal viewing angles occurring in the conventional single biaxial film compensation can be improved and contrast and sharpness at viewing angles close to the horizontal viewing angles are improved, while light leaking is reduced and the light leaking zone is limited to a relatively small range of viewing angle.

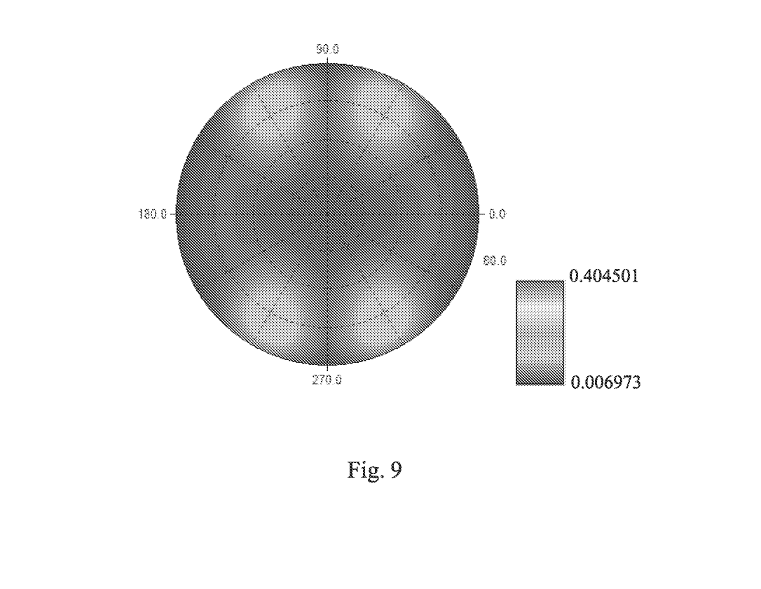

For example, for LC Δnd=352.1 nm, pre-tilt angle=89 degrees, compensation values of single biaxial compensation film being Ro=66 nm, Rth=220 nm, and compensation values of the TAC layer being Rth=82.6 nm, the schematic view of FIG. 9 that illustrates dark state light leaking distribution after improvement made by using the VA display mode compensation architecture according to the present invention can be obtained. The light leaking distribution of FIG. 9 is illustrated in terms of brightness with respect to viewing angle, wherein four concentric circles are shown in the drawing and respectively indicate, from inside to outside, vertical viewing angle of 20 degrees, 40 degrees, 60 degrees, and 80 degrees. The digits marked outside the 80-degree circle indicate horizontal viewing angle.

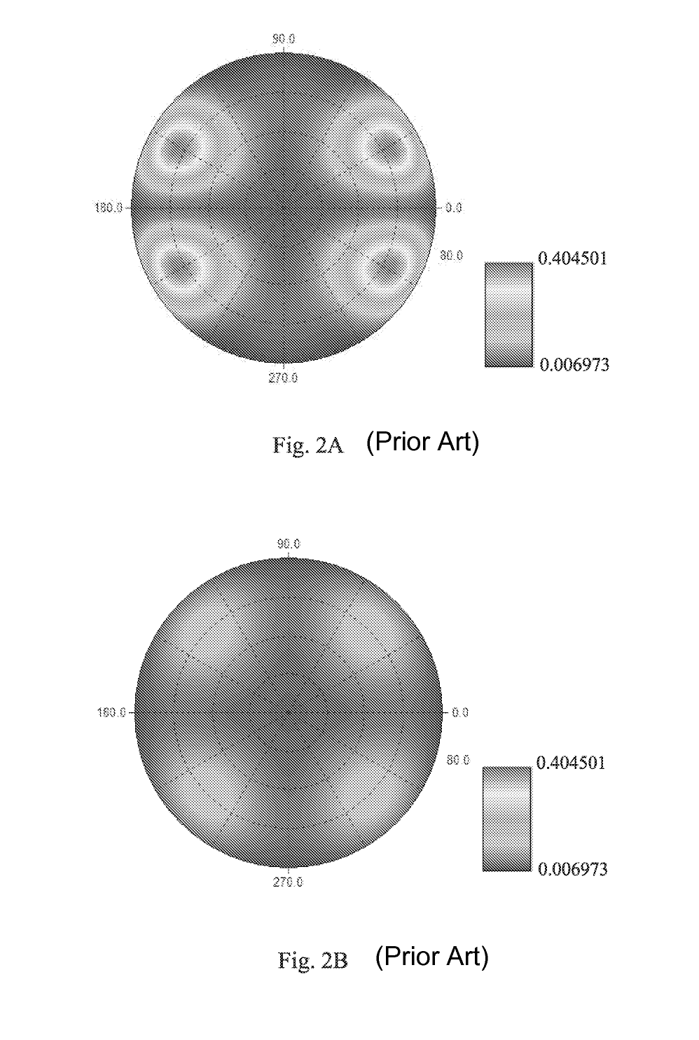

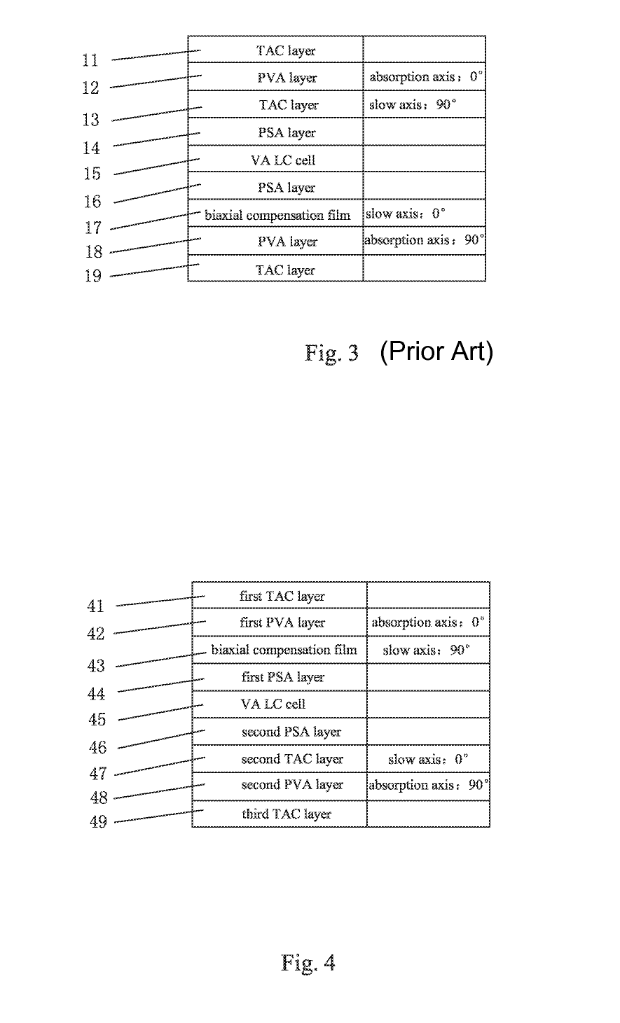

A comparison between FIG. 9 and FIG. 2A shows that after the improvement, dark state light leaking of compensation made with the single biaxial compensation film is concentrated around the vertical viewing angles and the light leaking range is confined in a small range of viewing angle. The amount of light leaking is apparently lower than the dark state light leaking occurring in the conventional single film compensation.

The VA display mode compensation architecture and the VA display mode liquid crystal display device according to the present invention impose limitation to the range of compensation of the compensation film, rather than being applied to a specific compensation film. Other compensation films, with the compensation values being identified within the range defined in the attached claims, are considered within the scope of projection of the claims.

In summary, the present invention provides a VA display mode compensation architecture, which angularly shifts viewing angles that have severe dark state light leaking toward the vertical viewing angles so as to improve contrast and sharpness of the viewing angles close to the horizontal viewing angles. With proper compensation value of the single biaxial compensation film and proper compensation value of the TAC layer, idea result of dark state light leaking can be achieved. The VA display mode liquid crystal display device has a sever dark state light leaking zone that is close to the upper and lower viewing angles and the dark state light leaking of viewing angles that are close to the horizontal viewing angles is apparently reduce to thereby effectively improve the contrast and sharpness of viewing angles close to the horizontal viewing angles.

Based on the description given above, those having ordinary skills of the art may easily contemplate various changes and modifications of the technical solution and technical ideas of the present invention and all these changes and modifications are considered within the protection scope of right for the present invention.

What is claimed is:

1. A Vertical Alignment (VA) display mode compensation architecture, comprising, sequentially from top to bottom, a first Triacetyl Cellulose (TAC) layer, a first polarization layer, a biaxial compensation film, a VA liquid crystal (LC) cell, a second TAC layer, a second polarization layer, and a third TAC layer, wherein the horizontal viewing angle of the VA LC cell and thus the VA liquid crystal display is taken as 0 degree for reference, the first polarization layer having an absorption axis that is set at 0 degree, the biaxial compensation film having a slow axis that is set at 90 degrees, the second TAC layer having a slow axis that is set at 0 degree, and the second polarization layer having an absorption axis that is set at 90 degrees.

2. The VA display mode compensation architecture as claimed in claim 1, wherein the first polarization layer and the second polarization layer are PVA layers.

3. The VA display mode compensation architecture as claimed in claim 1, wherein the VA LC cell is provided, respectively at upper and lower sides thereof, with PSA layers.

4. The VA display mode compensation architecture as claimed in claim 1, wherein the VA LC cell has phase retardation LC Δnd that is 342.8-361.4 nm.

5. The VA display mode compensation architecture as claimed in claim 1, wherein the VA LC cell has a pre-tilt angle having a range of [85, 90) degrees.

6. The VA display mode compensation architecture as claimed in claim 1, wherein the biaxial compensation film has in-plane retardation Ro that is 54-78 nm and the biaxial compensation film has a thickness retardation Rth that is 180-260 nm.

7. The VA display mode compensation architecture as claimed in claim 1, wherein the VA LC cell is a multi-domain VA LC cell.

8. The VA display mode compensation architecture as claimed in claim 7, wherein the VA LC cell is a four-domain or eight-domain VA LC cell.

9. A Vertical Alignment (VA) display mode compensation architecture, comprising, sequentially from top to bottom, a first Triacetyl Cellulose (TAC) layer, a first polarization layer, a biaxial compensation film, a VA liquid crystal (LC) cell, a second TAC layer, a second polarization layer, and a third TAC layer, wherein the horizontal viewing angle of the VA LC cell and thus the VA liquid crystal display is taken as 0 degree for reference, the first polarization layer having an absorption axis that is set at 0 degree, the biaxial compensation film having a slow axis that is set at 90 degrees, the second TAC layer having a slow axis that is set at 0 degree, and the second polarization layer having an absorption axis that is set at 90 degrees;
wherein the first polarization layer and the second polarization layer are PVA layers;
wherein the VA LC cell is provided, respectively at upper and lower sides thereof, with PSA layers;
wherein the VA LC cell has phase retardation LC Δnd that is 342. 8-361.4 nm;
wherein the VA LC cell has a pre-tilt angle having a range of [85, 90) degrees;
wherein the biaxial compensation film has in-plane retardation Ro that is 54-78 nm and the biaxial compensation film has a thickness retardation Rth that is 180-260 nm;
wherein the VA LC cell is a multi-domain VA LC cell; and
wherein the VA LC cell is a four-domain or eight-domain VA LC cell.

10. A display mode liquid crystal display device, comprising, sequentially from top to bottom, a first Triacetyl Cellulose (TAC) layer, a first polarization layer, a biaxial compensation film, a first substrate, a Vertical Alignment liquid crystal (VA LC) cell, a second substrate, a second TAC layer, a second polarization layer, and a third TAC layer, wherein the horizontal viewing angle of the VA LC cell and thus the VA mode liquid crystal display device is taken as 0 degree for reference, the first polarization layer having an absorption axis that is set at 0 degree, the biaxial compensation film having a slow axis that is set at 90 degrees, the second TAC layer having a slow axis that is set at 0 degree, and the second polarization layer having an absorption axis that is set at 90 degrees.
